(19) United States
(12) Patent Application Publication
(10) Pub. No.: US 2011/0260097 A1
(43) Pub. Date: Oct. 27, 2011

(54) ADDITIVE FOR ALKALINE ETCHING SOLUTIONS, IN PARTICULAR FOR TEXTURE ETCHING SOLUTIONS, AND PROCESS FOR PRODUCING IT

(75) Inventors: Ihor Melnyk, Konstanz (DE); Jens Kruemberg, Konstanz (DE); Michael Schmidt, Konstanz (DE); Michael Michel, Berlin (DE)

(73) Assignee: GP SOLAR GMBH, Konstanz (DE)

(21) Appl. No.: 13/128,052

(22) PCT Filed: Nov. 5, 2009
(86) PCT No.: PCT/IB2009/007328

§ 371 Date: May 31, 2011

(30) Foreign Application Priority Data
Nov. 6, 2008 (DE) 10 2008 056 086.3

(51) Int. Cl. C09K 13/02; C09K 13/00

(52) U.S. Cl. 252/79.5; 252/79.1

(57) ABSTRACT

A product is obtained by mixing at least one polyethylene glycol with a base, allowing the mixture to rest in ambient air and at a temperature of approximately 25 degrees Celsius to form two phases, and separating the less dense phase representing the product. The product is used as an additive to etching solutions.

The invention relates to a product, its usage as an additive or component of etching solutions and to a process for producing it.

When etching materials, one often strives to obtain a defined etching result with respect to kind, position and/or extent of the etching. This is particularly the case when semiconductor materials are etched, as it is done for example during manufacturing of electronic devices or solar cells. Mostly silicon, among others multicrystalline silicon, is used as semiconductor material, whereas multicrystalline silicon is used at an industrial scale during the manufacturing of multicrystalline silicon solar cells. A defined etching of multicrystalline materials, in particular multicrystalline silicon, is, however, expensive, since the differing grains and any crystal defects present are etched in varying degrees by most etching solutions. This is, for example, the case of alkali hydroxide-based alkaline etching solutions, which are used on an industrial scale in the etching and in particular in the texture etching of silicon wafers. It is certainly possible to use other etching solutions, which etch the semiconductor materials evenly regardless of the crystal orientation and crystal defects. But their use on an industrial scale is problematic and expensive, mostly for reasons of safety or disposal, so that despite the anisotropic etching effect, alkaline etching solutions based on alkali hydroxides are frequently preferred.

In order to achieve a defined etching result with these, it is, however, necessary to co-ordinate the respective etching process precisely to the silicon material specifically used. Factors influencing etching parameters such as etching time, composition of the etching solution and etching temperature can be, inter alia, the type of crystallisation of the semiconductor material used, e.g. block-cast or edge-stabilised drawn multicrystalline silicon or again, monocrystalline silicon, the dopant type and dopant thickness thereof and also the type and density of the crystal defects. In practice, the result of this is that different etching parameters must be used in each case, even for the various silicon materials of one manufacturer. Their multiplicity increases still more when materials from various manufacturers are used. Especially in the case of texture etchings, such as those frequently employed in the production of solar cells to form a surface structure in order to increase the injection of light, the sensitivity of the texture etching processes with respect to the material used gives rise to a large number of different sets of etching parameters.

The present invention is therefore based on the problem of providing a product which enables the etching processes, especially texture etching processes, to be simplified.

This problem is solved by a product obtained in the way explained in claim 1.

The invention is also based on the problem of providing a method for the production of this product.

This problem is solved by a method with the features of claim 10.

Advantageous refinements form in each case the subject matter of dependent sub-claims.

The product according to the invention is obtainable by mixing at least one polyethylene glycol with a base, allowing the resulting mixture to rest in ambient air at a temperature of about 25° C. in order to form two phases and separating the less dense phase representing the product. The term base in this case means, in principle, any compound and any element capable of forming hydroxide ions in aqueous solution. For preference, the base used is an alkali hydroxide, especially preferably potassium hydroxide or sodium hydroxide. Ambient air in the present sense is a gas mixture, such as that usually found on the earth in areas occupied by human beings. The term ‘allow to rest’ in this case does not necessarily mean an absolute rest of the mixture. In principle the mixture can also be moved, although this can hinder the separation of the phases in a given case. In principle all polyethylene glycols can be used for the production of the product. In practice, the use of tetraethylene glycol has been proven. When this is used, the two phases of different density typically form after a few minutes of being left to rest.

It has emerged that adding the product according to the invention to alkaline etching solutions, in particular to texture etching solutions, can have an advantageous effect on the etching processes. So, as the result of the admixture, the etching solution can be used for various types and qualities of a semiconductor material using the same etching parameters and with equivalent etching results, for example in the same way for p-doped as well as for n-doped silicon. The number of etching parameter sets required, known as etching recipes, can therefore be significantly reduced. This reduction in the number of etching recipes required further simplifies, insofar this may even be necessary, the adaptation of the composition of the etching solution and also the etching parameters to the semiconductor material to be etched. Moreover, an extended service life of the etching solution may result.

If the product according to the invention is mixed into alkaline texture etching solutions, further advantages may also arise. For example, with the same etching solution and identical etching parameters, mono- and also multicrystalline semiconductor materials, in particular silicon wafers, can be textured. In the state of the art, for example for silicon wafers, aqueous texture etching solutions are used as texture etching solutions, which contain 0.5 to 6 wt. % in alkali hydroxides and 1 to 10 volume % alcohols, mostly isopropyl alcohol (cf. e.g. U.S. Pat. No. 3,998,659). The texture etching here usually takes place at a temperature of 70 to 90° C. during a period of typically 20 to 75 minutes. When the product according to the invention is mixed into alcohol-containing alkaline etching solutions, it has emerged that the etching time can be reduced as a result and furthermore the amount of alcohol used in the alkaline etching solution can be reduced.

In the case of semiconductor materials separated from a block by means of a sawing process, for example silicon wafers separated by means of an annular or a wire saw from a silicon block, it has previously been necessary firstly to remove the saw damage by a separate, saw damage etching process, conducted in advance, before a texturing with structures with dimensions in the micron range can be reliably applied by means of a texture etching solution. When the product according to the invention is mixed into the texture etching solution, however, the separate saw damage etching process can be dispensed with and the etching of the saw damage can be conducted in a joint process step together with the texturing of the surface of the semiconductor material.

The advantageous effects described are not reliant on the same bases being used for the production of the product according to the invention and in the alkaline etching solution. For example, sodium hydroxide can be used for the production of the product according to the invention, but the product is then mixed into a solution containing potassium hydroxide.

In one advantageous variant embodiment of the invention, the less dense phase is allowed to rest in ambient air until it takes on a colour, preferably until it adopts an orange colour. The less dense phase is initially colourless, but changes colour with increasing resting time. It has emerged that the product according to the invention is especially effective when an orange colour is present. The resting period conveniently takes place before the separation of the less dense phase. The resting time varies according to the composition of the mixture and, when potassium hydroxide or sodium hydroxide is used as base, is about 1 to 2 hours.

In one refinement of the invention, water is mixed into the polyethylene glycol and the base prior to formation of the two phases. The water is preferably mixed in by mixing the base, in the form of an aqueous solution of this base, for example an aqueous alkali hydroxide solution, into the at least one polyethylene glycol. By admixing the water, on the one hand there is a tendency for the colouration of the less dense phase to slow down, which in this case takes about 1 to 16 hours. On the other hand the product according to the invention can be stored for longer before it loses its effectiveness. This may be advantageous to the application.

In one advantageous variant embodiment, alcohol, water and alkali hydroxides are mixed into the separated less dense phase. For preference, the alcohol used is isopropyl alcohol, and sodium hydroxide or potassium hydroxide is used as alkali hydroxide. In this way an etching or texture etching solution can be made available which is advantageous in one of the ways described above. The alcohol, the alkali hydroxide and the water in this case are in such proportion to each other that without the separated phase, they would form an aqueous solution with 0.5 to 6 wt. % in alkali hydroxides and 1 to 10 volume % alcohol. The volume % of the separated phase of the total solution amounts to about 0.01 to 5%, preferably 0.01 to 1% and especially preferably 0.07 to 0.3%.

All variant embodiments of the product according to the invention can be used advantageously as additives in alkaline etching solutions for semiconductor materials, preferably in alkaline etching solutions for inorganic semiconductor materials such as silicon. They have proven to be advantageous especially as additive for texture etching solutions.

In the variant embodiment described, with admixed alcohols, water and alkali hydroxides, the product according to the invention can itself be used as texture etching solution for semiconductor materials, preferably for inorganic semiconductor materials and especially preferably for silicon materials. For example, with this variant embodiment a surface texturing with randomly oriented, inverted pyramids can be produced on silicon surfaces. The height of the pyramids in this case can be influenced by the ratio of the separated phase to the etching solution.

In the method according to the invention for the production of the product, at least one polyethylene glycol is mixed with a base and after the formation of two phases in the resulting mixture, the less dense phase, which represents the product, is separated. The term base in this case is to be understood in the sense explained above. The formation of the two phases can, for example, take place by simply allowing the mixture to rest in ambient air for a few minutes. In principle, however, the mixture for the formation of the two phases can also be moved, although this can hinder the separation of the phases in a given case, insofar as this is done with the aid of gravity. In principle, however, the phases of different density can be separated in any way known in the art, for example by means of centrifuging.

One refinement of the method according to the invention makes provision that prior to formation of the two phases, the mixture is brought to a temperature of between 20° C. and 100° C., preferably to a temperature of between 60° C. and 100° C. and especially preferably to a temperature of between 75° C. and 85° C. The heating necessary for this is preferably switched off after reaching the target temperature. The provision of energy accelerates the formation of the two phases.

In one advantageous variant embodiment of the invention, a change of colour of the originally colourless less dense phase is awaited. Preferably a change of colour to an orange colour is awaited. This can be achieved, for example, by allowing the separated phase to rest in ambient air and at room temperature, i.e. approx. 20° C. The resting time in that case is preferably about 1 to 2 hours. The separation of the less dense phase advantageously occurs only after the end of the resting time as this means it can simultaneously be used for the cooling thereof, insofar as the mixture has previously been heated as explained above.

One refinement of the method according to the invention makes provision that water is mixed into the mixture consisting of at least one polyethylene glycol and a base prior to the formation of the two phases. This preferably occurs by mixing the at least one polyethylene glycol with an aqueous solution of the base, for example with an aqueous alkali hydroxide solution. In this way, as explained above, the product according to the invention can be produced in a form which can be stored for longer. Any resting time until the change of colour of the less dense phase to an orange colour is extended by the admixture of water. In this case this is about 1 to 16 hours, while the precise time appears to depend on the ambient conditions and the precise composition of the mixture.

The invention will next be explained in more detail with the aid of the figures. Elements which have the same effect, insofar as useful, have been given the same reference numbers. The figures show:

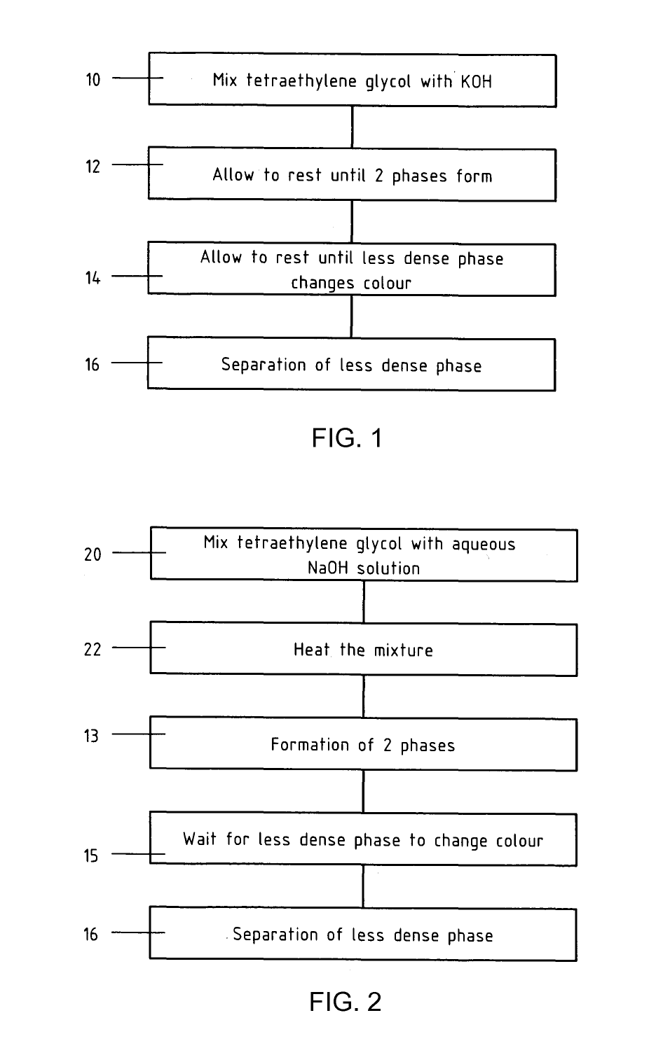

FIG. 1 schematic view of the production of one embodiment of the product according to the invention

FIG. 2 schematic view of one embodiment of the method according to the invention

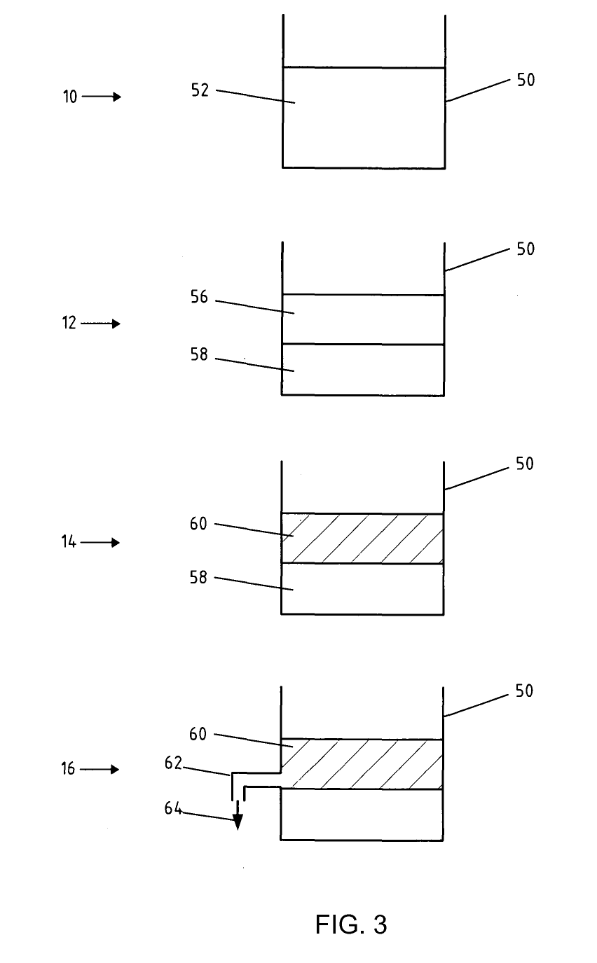

FIG. 3 illustration of the method steps of the embodiment from FIG. 1

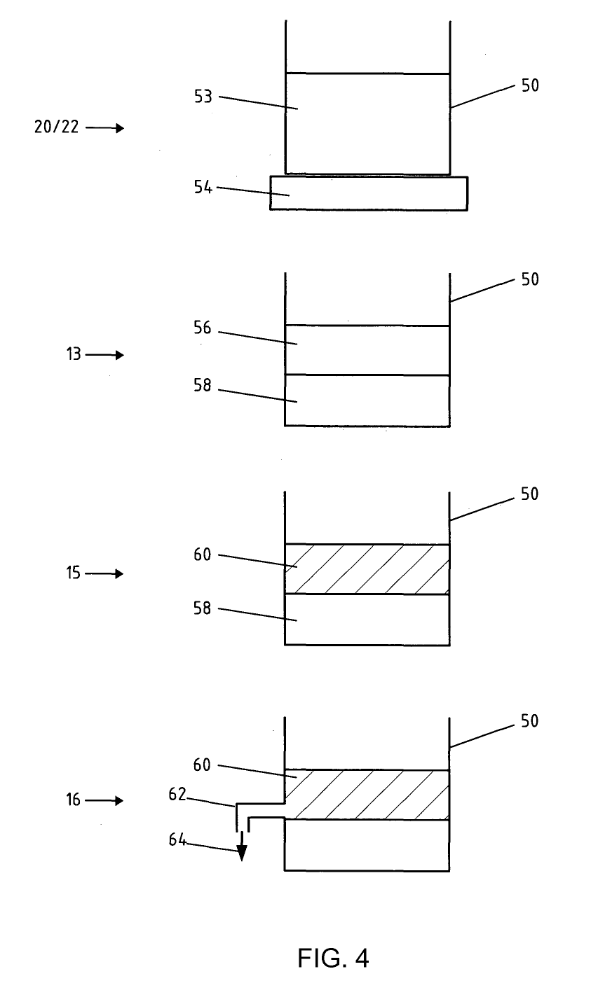

FIG. 4 illustration of the method steps of the embodiment from FIG. 2

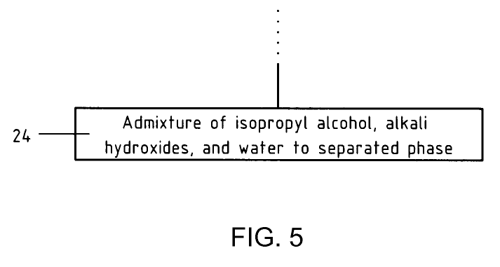

FIG. 5 refinement option for the embodiments from FIGS. 1 and 2

FIG. 1 shows the production of one embodiment of a product according to the invention in schematic view. The individual method steps of this embodiment are also illustrated in FIG. 3. In this embodiment, tetraethylene glycol is used as the at least one polyethylene glycol and potassium hydroxide (KOH) is used as base. These components are mixed 10. The mixture 52 which results and is placed in accordance with the illustration in FIG. 3 in a container 50, is then allowed to rest 12, until two phases 56, 58 form. This takes place in the present case in ambient air and at room temperature, i.e. about 20° C. Thereafter the originally colourless less dense phase 56 is again allowed to rest 14, until it takes on a colour, preferably an orange colour. The coloured less dense phase 50 is then separated from the more dense phase 16. In the view from FIG. 3, this is indicated schematically by a sequence 62, through which the separated less dense phase 64 runs. In practice the separation of the two phases 60, 58 can take place in any way known in the art.

FIG. 2 shows a schematic embodiment of a method according to the invention. The method steps of this are also illustrated in FIG. 4. In the embodiment shown in FIG. 2, the starting point is tetraethylene glycol and an aqueous sodium hydroxide solution (NaOH solution), which are firstly mixed together 20. The resulting mixture 53 is brought to a temperature of between 20° C. and 100° C. by means of a heating device 54, preferably to a temperature in the range between 60° C. and 100° C. and especially preferably being heated 22 to a temperature of between 75° C. and 85° C. Thereafter, two phases 56, 58 are formed 13 in the mixture 53. This can occur simply by allowing the mixture to rest for a few minutes, so that the phases of lesser 56 and greater density 58 separate, as shown in FIG. 4. In principle, however, the separation can also take place under movement, for example using a centrifuge. Thereafter a change of colour of the less dense phase 56 is awaited 15, preferably a change of colour into an orange colour. The coloured less dense phase 60 is then separated 16, as shown schematically in FIG. 4, again indicated by the sequence 62 through which the separated less dense phase 64 runs. In practice the separation of the two phases 60, 58 may take place in any way known in the art.

Obviously, the procedure according to the illustrations in FIGS. 1 and 3 simultaneously represents a further embodiment for a method according to the invention.

Both in the embodiment from FIG. 1 and in the embodiment from FIG. 2, mixtures of one or more of any polyethylene glycols, in particular of tetraethylene glycol, with any alkali hydroxides or an aqueous solution of any alkali hydroxides can be used. In particular, the use of NaOH or an aqueous KOH solution is thus also possible.

One embodiment of a refinement of the product according to the invention according to the embodiment from FIGS. 1 and 3, together with the method according to the invention according to the embodiment from FIGS. 2 and 4 is illustrated in FIG. 5. The procedure, shown therein schematically, of the admixture 24 of isopropyl alcohol, alkali hydroxides and water to the separated less dense phase 64 can in both cases follow the separation 16 of the less dense phase. The resulting product can be used as etching solution, in particular as a texture etching solution, and has proven itself in texture etchings of silicon materials. For preference, NaOH or KOH are used as alkali hydroxides, in which case these can be selected independently of the base used in the mixture 52, 53. In practice, an aqueous solution has proven itself as admixture, which contains 0.5 to 6 wt. % in alkali hydroxides and 1 to 10 volume % isopropyl alcohol. A volume % of the separated phase 64 in the resulting solution of 0.01 to 5% has proven itself. Preferably, the volume % is 0.01 to 1% and especially preferably 0.07 to 0.3%.

Etching solutions with this volume % of separated phases 64 can be used especially advantageously as texture etching solutions for semiconductor materials, in particular for silicon, since they enable reliable etching results for various qualities of the silicon material to be etched without any major adaptation of the etching parameters.

### LIST OF REFERENCE NUMBERS

10 mixing of tetraethylene glycol with potassium hydroxide (KOH)
12 mixture allowed to rest to form two phases
13 formation of two phases
14 less dense phase allowed to rest until it changes colour
15 wait until the less dense phase changes colour
16 separation of the less dense phase
20 mixing tetraethylene glycol with aqueous sodium hydroxide solution (NaOH solution)
22 heating of mixture
24 admixture of isopropyl alcohol, potassium hydroxide and water to separated phase
50 container
52 mixture
53 mixture
54 heating device
56 less dense phase
58 more dense phase
60 less dense phase after changing colour
62 sequence
64 separated less dense phase

1-15. (canceled)

16. A product, comprising a material having the characteristics of having been obtained by:
mixing at least one polyethylene glycol with a base;
allowing the mixture to rest under ambient air and at a temperature of approximately 25° C. until two phases have formed; and
separating the phase of smaller density which represents the product.

17. The product according to claim 16, wherein said base is an alkali hydroxide.

18. The product according to claim 17, wherein said alkali hydroxide is sodium hydroxide or potassium hydroxide.

19. The product according to claim 16, wherein said at least one polyethylene glycol is tetraethylene glycol.

20. The product according to claim 16, wherein said less dense phase is a phase having been allowed to rest in ambient air until the less dense phase has taken on color.

21. The product according to claim 20, wherein said less dense phase has taken on an orange color.

22. The product according to claim 16, wherein water is mixed into the mixture.

23. The product according to claim 16, wherein said separated, less dense phase has alcohol, water, and alkali hydroxides mixed therein.

24. The product according to claim 23, wherein said alcohol is isopropyl alcohol and said alkali hydroxides are selected from the group consisting of sodium hydroxide and potassium hydroxide.

25. The product according to claim 23, wherein said separated phase has a volume percentage of 0.01 to 5%.

26. The product according to claim 23, wherein said separated phase has a volume percentage of 0.01 to 1%.

27. The product according to claim 23, wherein said separated phase has a volume percentage of 0.07 to 0.3%.

28. A composition of matter, comprising an alkaline etching solution for semiconductor material containing the product according to claim 16 as additive.

29. The composition according to claim 28, wherein said etching solution with said additive is configured for etching inorganic semiconductor materials.

30. The composition according to claim 28, wherein the product has alcohol, water, and alkali hydroxides mixed therein and the etching solution with said additive is configured for texture etching semiconductor materials.

31. The composition according to claim 30, wherein the etching solution with said additive is configured for texture etching silicon.

32. A method for producing the product according to claim 16, the method which comprises:
mixing at least one polyethylene glycol with a base to form a mixture;
allowing two phases to form from the mixture including a less dense phase; and
separating the less dense phase representing the product.

33. The method according to claim 32, wherein the base is an alkali hydroxide.

34. The method according to claim 32, wherein the base is selected from the group consisting of sodium hydroxide and potassium hydroxide.

35. The method according to claim 32, which comprises using tetraethylene glycol as the at least one polyethylene glycol.

36. The method according to claim 32, which comprises awaiting a change in color of the less dense phase.

37. The method according to claim 36, which comprises awaiting a change in color of the less dense phase to an orange color.

38. The method according to claim 32, which comprises, prior to a formation of the two phases, bringing the mixture to a temperature of between 20° C. and 100° C.

39. The method according to claim 38, which comprises, prior to the formation of the two phases, bringing the mixture to a temperature of between 60° C. and 100° C.

40. The method according to claim 38, which comprises, prior to a formation of the two phases, bringing the mixture to a temperature of between 75° C. and 85° C.

41. The method according to claim 32, which comprises admixing water into the mixture.

42. The method according to claim 32, which further comprises employing the product as an additive in an alkaline etching solution for semiconductor materials.

43. The method according to claim 42, which comprises employing the product as an additive in an alkaline etching solution for inorganic semiconductor materials.

44. The method according to claim 32, which further comprises mixing alcohol, water, and alkali hydroxides in the less dense phase, and employing the product as a texture etching solution for semiconductor materials.

45. The method according to claim 44, which comprises using the product as a texture etching solution for etching silicon.
